(19) United States
(12) Patent Application Publication
(10) Pub. No.: US 2008/0005098 A1
(43) Pub. Date: Jan. 3, 2008

(54) SYSTEM FOR USING BUSINESS VALUE OF PERFORMANCE METRICS TO ADAPTIVELY SELECT WEB CONTENT

(76) Inventors: Alexander W. Holt, New Paltz, NY (US); William J. Hunt, Farmington, CT (US); Joseph M. Lopatka, Katonah, NY (US); Michael E. Moran, Ridgewood, NJ (US); Jeffrey S. Schaffer, Ridgefield, CT (US)

Correspondence Address: HOFFMAN, WARNICK & D'ALESSANDRO LLC, 75 STATE ST, 14 FL, ALBANY, NY, 12207, US

(21) Appl. No.: 11/428,088

(22) Filed: Jun. 30, 2006

(51) Int. Cl. G06F 17/30

(52) U.S. Cl. 707/5

(57) ABSTRACT

A system and method for adaptively selecting content items to be displayed to users visiting a web portal. A system is disclosed that includes a content selection system for selecting a content item from a set of content items to display to a user based on a profile of the user and a set of business value scores associated with the set of content items; a data collection system for collecting performance metrics for users presented with the content items; an initialization system for generating an initial set of business value scores; and a business value generator for adaptively modifying the set of business value scores over time based on the performance metrics.

### FIELD OF THE INVENTION

The invention relates generally to dynamically selecting web content to be displayed to a user, and more particularly relates to a system and method of using the calculated business value of collected performance metrics to adaptively select web content for the user.

### BACKGROUND OF THE INVENTION

Most commercial web sites are implemented to achieve some business goal, e.g., sell goods and services, provide automation to reduce operational costs, etc. The business impact of the website is greatly determined by the content being displayed to the users. One way to improve the business impact is to provide a website (also referred to herein as a “portal”) that can select and display different content items to different users based on, e.g., user preferences and profiles. Unfortunately, it is very difficult to automatically assess and optimize the business impact of such content selections to the users.

Typical solutions include surveying site visitors to understand their interaction with the website, and then make educated guesses on how to improve the value to the business and end user. Unfortunately, such solutions have several drawbacks, including: intrusiveness to the site visitor and/or customer, slow turnaround time in getting responses and implementing changes, overall vagueness in understanding how to address the problems, and inability to measure the specificity of the change to the overall impact of the website.

These solutions may include tracking metrics, such as click through rates, to determine which content items are the most popular. Unfortunately, such strategies cannot automatically adapt to changing user preferences over time, e.g., what is popular this month may not be popular next month. Moreover, click through rates are not necessarily an accurate measure of the business impact. For instance, consider a customer services website for a software company in which a download solution to a frequently asked question may get a lot of click through traffic, but still not result in a satisfactory solution for a percentage of customers, thus resulting in expensive telephone calls to the helpline. Conversely, a work-around solution to the same issue may drive less click through traffic, but result in almost no calls to the helpline. In such a situation, the business impact of the work-around solution may be significantly greater in terms of cost savings to the business, even though more users opt for the download solution. Over time however, the work-around solution may be less viable and result in an increasing number of calls.

Current solutions cannot automatically measure the business impact and adapt to the changing needs and behaviors of the users. Accordingly, a need exists for a system and method that can automatically measure the business impact of content selections and adaptively select content for users.

### SUMMARY OF THE INVENTION

The present invention addresses the above-mentioned problems, as well as others, by providing a system and method of using the calculated business value instead of simple collected performance metrics to dynamically select web content for the user.

In a first aspect, the invention provides a web portal having an adaptive content management system for selectively displaying content to users, comprising: a content selection system for selecting a content item from a set of content items to display to a user based on a profile of the user and a set of business value scores associated with the set of content items; a data collection system for collecting performance metrics for users presented with the content items; an initialization system for generating an initial set of business value scores; and a business value generator for adaptively modifying the set of business value scores over time based on the performance metrics.

In a second aspect, the invention provides a computer program product stored on a computer usable medium for selecting content to display to users visiting a network site, comprising: program code configured for selecting a content item from a set of content items based on a profile of a user and a set of business values scores associated with the set of content items; program code configured for collecting performance metrics for users presented with the content items; program code configured for implementing an initial set of business value scores; and program code configured for adaptively modifying the set of business value scores over time based on the performance metrics.

In a third aspect, the invention provides a method for selecting content to display to users visiting a network site, comprising: implementing an initial set of business value scores for a set of content items; selecting content items for display to users from the set of content items based on the initial set of business value scores; collecting performance metrics for users presented with the content items; and rescoring the set of business value scores over time based on the performance metrics.

In a fourth aspect, the invention provides a method for deploying an adaptive content management system, comprising: providing a computer infrastructure being operable to: implement an initial set of business value scores for a set of content items; select content items for display to users from the set of content items based on the initial set of business value scores; collect performance metrics for users presented with the content items; and rescore the set of business value scores over time based on the performance metrics.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a web portal having an adaptive content management system in accordance with an embodiment of the present invention.

FIGS. 2-14 depict data associated with an illustrative example of an implementation of a web portal using the adaptive content management system of FIG. 1.

### DETAILED DESCRIPTION OF THE INVENTION

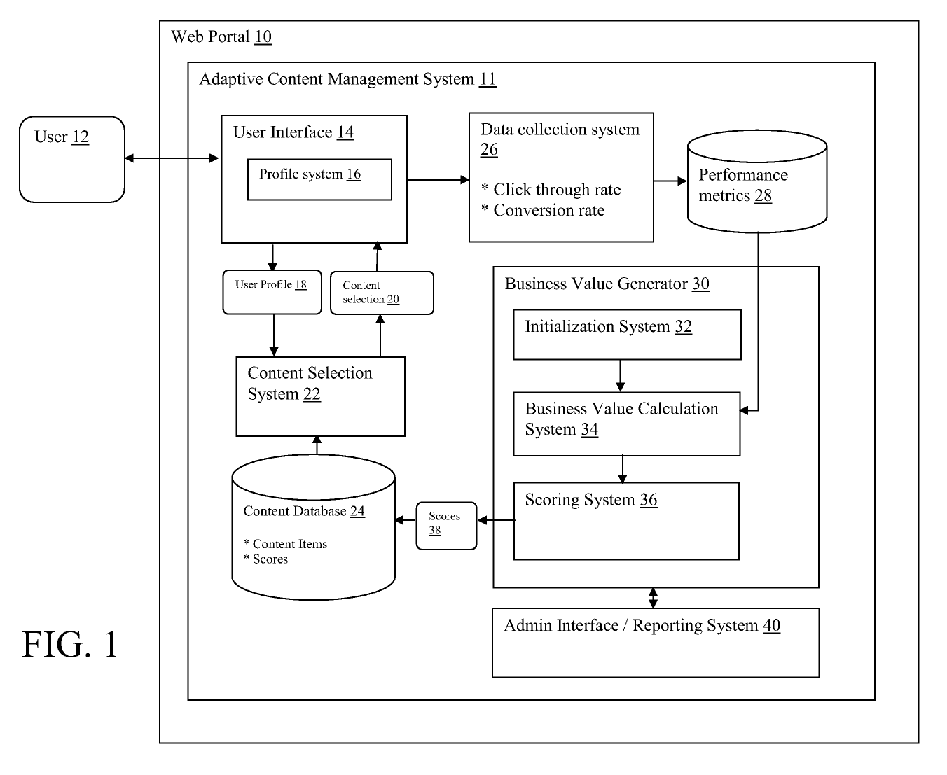

Referring now to drawings, FIG. 1 depicts a web portal 10 having an adaptive content management system 11 that can adaptively select and display content items to a user 12 based on the business value derived from collected performance metrics 28.

An illustrative implementation of adaptive content management system 11 is as follows. User 12 points a browser (or similar system) to the web portal 10 (or other network site), and a user interface 14, such as a web page, is provided to the user 12. A content database 24 is provided that includes a set of possible content items that can be presented to the user 12. A web application server is provided that can dynamically select and display different content items and select the placement of content items. Content items may include any type of content suitable for presentation via the user interface 14, e.g., an entire web page, an advertisement, a search result, a link, a marketing campaign, etc. A content selection system 22 makes a content selection 20 to determine which particular content item (or items) to present to user 12 based on: (1) a user profile 18; and (2) a set of business value scores 38 assigned to the different content items in the content database 22. Profile system 16 determines the user profile 18 of the user 12 based on any now known or later developed technique (e.g., a login, cookies, heuristics, etc.). Business value scores 38 are determined by a business value generator 30 (described in further detail below).

Accordingly, for a given user profile 18, there may exist n different possible content items that could be displayed. Each of the n content items are assigned a business value score 38 that measures the relative performance of each content item. Then, anytime a user having the given user profile 18 visits the web portal 10, content selection system 22 selects one of the n content items based on the business value scores 38. In particular, content selection system 22 will select each given content item with a relative frequency derived from the business value scores 38 assigned to the content items. For instance, assume there are three content item choices having business value scores as follows for a user of profile type x: item A=0.30; item B=0.65; and item C=0.05. In this case, each time a user 12 having a user profile of type x visits the web portal 10, item A is presented 30% of the time, item B is presented 65% of the time, and item C is presented 5% of the time. Thus, although item B has the highest business value score, it is not selected and displayed each time a user profile of type x is encountered. Instead, content items get displayed with different frequencies. This allows the adaptive content management system 11 to adapt to changing user preferences over time.

Business value scores 38 are determined by business value generator 30 based on collected performance metrics 28, which are collected by data collection system 26. In particular, when users are presented with a content item, data collection system 26 tracks performance metrics 28, which may include a click through rate (i.e., number of times clicked) and more importantly, a conversion rate. The conversion rate tracks the number of conversions that resulted from the user 12 clicking on a presented content item. For instance, if the user 12 was presented with a particular marketing campaign for some goods or services, and the user 12 purchased the goods or services, then a conversion occurred. In such cases, the performance metrics 28 could also store the sale amount or projected sale generated by each conversion.

In other cases, a conversion may indicate a cost savings, e.g., the content item may provide guidance to allow a user 12 to solve an information technology (IT) problem without a call to the help desk. In this case, a time or cost savings may be stored with the performance metrics for each conversion. Still in other cases, the conversion may indicate that the user filled out a form to be contacted by a salesperson. For the purpose of this disclosure, a conversion simply refers to some action taken by the user beyond simply clicking on a content item.

Initially, before any performance metrics 28 are collected, the business value scores 38 associated with each content item in the content database 24 are arrived at using an initialization system 32. Initialization system 32 allows a system administrator or the like (e.g., a marketing team) to make some initial guesses regarding what the business values scores 38 should be. For instance, the system administrator may make an educated guess that 10,000 visitors will come to the site each week, and if content Items A, B and C are presented equally, content item A will result in 200 click throughs and 10 sales. Educated guesses are then also made that content items B and C will result in 100 and 500 click throughs and 5 and 25 sales, respectively. Business value calculation system 34 would then associate a business value (or dollarized conversion value) to each content item, e.g., based on a projected number of impressions for each content item, content item A will generate $20,000 in revenue, content item B will generate $25,000 in revenue, and content item C will result in $5,000 in revenue. Such dollarized conversion values could thus also be calculated/presented based on business value per impression.

Scoring system 36 would then assign a business value score 38 to each content item based on the calculated business values, e.g., content item A=0.4, content item B=0.5, and content item C=0.1. In this case, the scores are calculated in terms of ratios, such that the sum of each equals “1”. However, any presentation for the business value scores 38 that provide a relative value of each could be used. These “initial” scores are then stored in the content database 24 with the content items.

It should be noted that while educated guesses for the initial scores can shorten the amount of time before optimal scoring values are attained, the invention will derive optimal values even if no initial distinction is entered between the different segments' viewing rate and click-through rates. In other words, equal values for these measurements can be used to initialize the system, and, so long as reasonably accurate business values (i.e., revenue and off-line conversion rates) are entered and maintained, the system will still self-optimize the scoring used in content selection over time.

As performance metrics 28 are collected over time, business value generator 30 can recalculate (i.e., adaptively modify) the business value scores 38, e.g., at regular time intervals or continuously. For example, business value calculation system 34 examines the conversion rates and generated (or projected) revenues to determine actual business values associated with each content item under the current model. For instance, at the end of the week, there may have been 12000 visitors, with 4800 being shown content item A, 6000 being shown content item B, and 1200 being shown content item C. Resulting click throughs, conversions and revenues may be 50 click throughs, 5 conversions, and $4000 in revenue for content item A; 200 click throughs, 40 conversions and $40,000 for content item B; and 50 click throughs, 5 conversions, and $6000 for content item C.

Based on the dollarized business values, scoring system 36 would rescore the business values scores 38 for content items A, B, C, as 0.08, 0.80, and 0.12, respectively. Over time, the web portal 10 would then collect new performance metrics 28 and rescore, and repeat again and again. In this manner, an adaptive model is provided to continuously identify and exploit the content items associated with the high business value.

Note that while in this example, dollarized business values based on revenue are utilized, other types of business values could likewise be calculated by the business value generator 30 to calculate business value scores 38. Examples of such business values include: cost savings, profit, total lifetime value, time, volume, customer type, etc.

In addition to those features and functions described above, an administrative interface/reporting system 40 is provided to allow a systems administrator or the like to enter initialization data and generate reports.

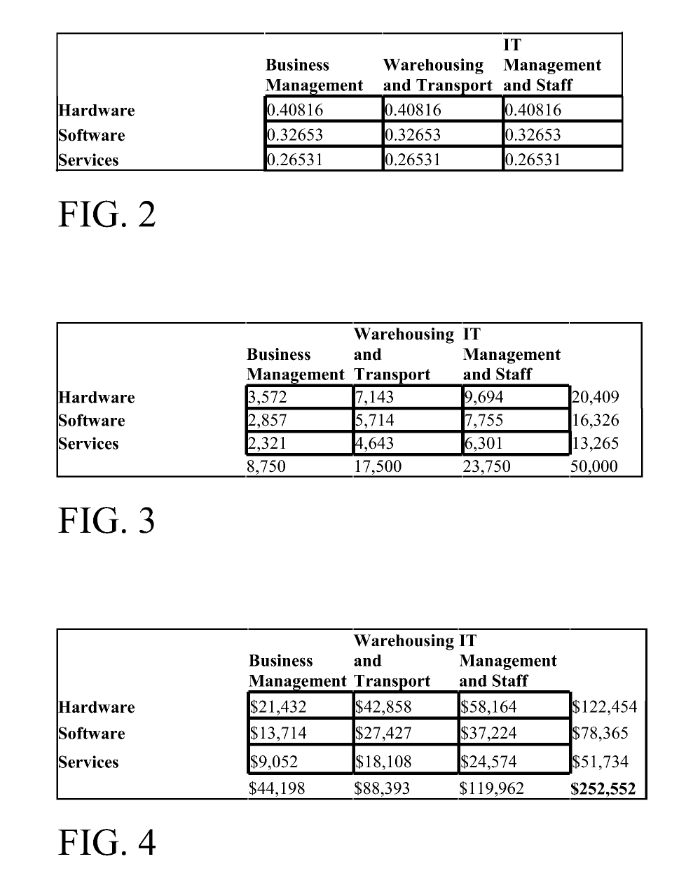

FIGS. 2-14 depict an example of an implementation of the adaptive content management system 11 shown in FIG. 1. This example assumes a scenario in which there are three possible marketing campaigns (i.e., content items) that can be shown to users visiting the web portal 10, which include: hardware, software and service. Also assumed is that there are three different user profiles: business management, warehousing and transport, and IT management and staff. The goal for the marketing team is to get the greatest web return on the campaign dollars spent. To achieve this, the marketing team must get the right campaign (i.e., content item) in front of the right users. Finally, assume that each campaign operates by allowing a user to click on a link (resulting in a click-through), and be given the opportunity to fill out a form (resulting in a post click conversion) to potentially generate an actual sale (resulting in a post web conversion).

The first step is to associate some initial business value scores 38 to each campaign for each user profile in the content database 24. In one illustrative methodology, the marketing team may use existing data to accomplish this. For instance, the team may assume that of the typical 10,000 visitors they receive each day, 1.5% will click through, 10% of those click throughs will complete the form, and 4% of those will purchase something. Using the initialization system 32 to enter the fact that an average hardware sale is $100,000, an average software sale is $80,000 and an average service sale is $65,000, initial business value scores 38 may be generated, such as those shown in FIG. 2. Based on the initial score, a business management user will be shown the hardware campaign about 40.8% of the time, the software campaign about 32.6% of the time, and the services campaign 26.5% of the time. FIG. 3 depicts the number of impressions that can be expected per campaign/user profile over a five day term, and FIG. 4 depicts the projected revenue, based on the forecasted percentages and average sales values stated above. Thus, using the initial business values scores, the marketing teams expects to generate $252,552 in revenue.

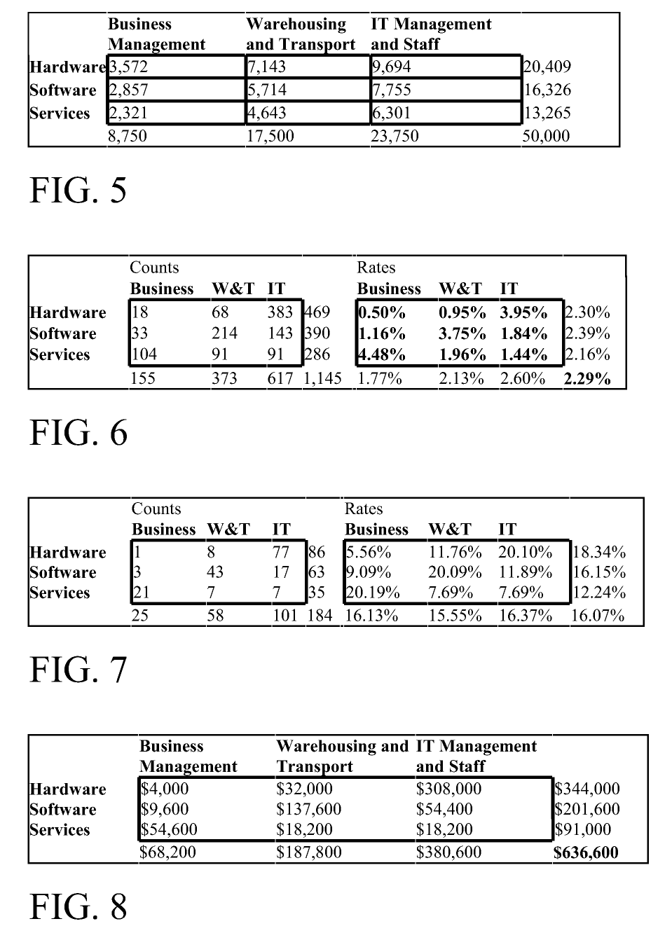

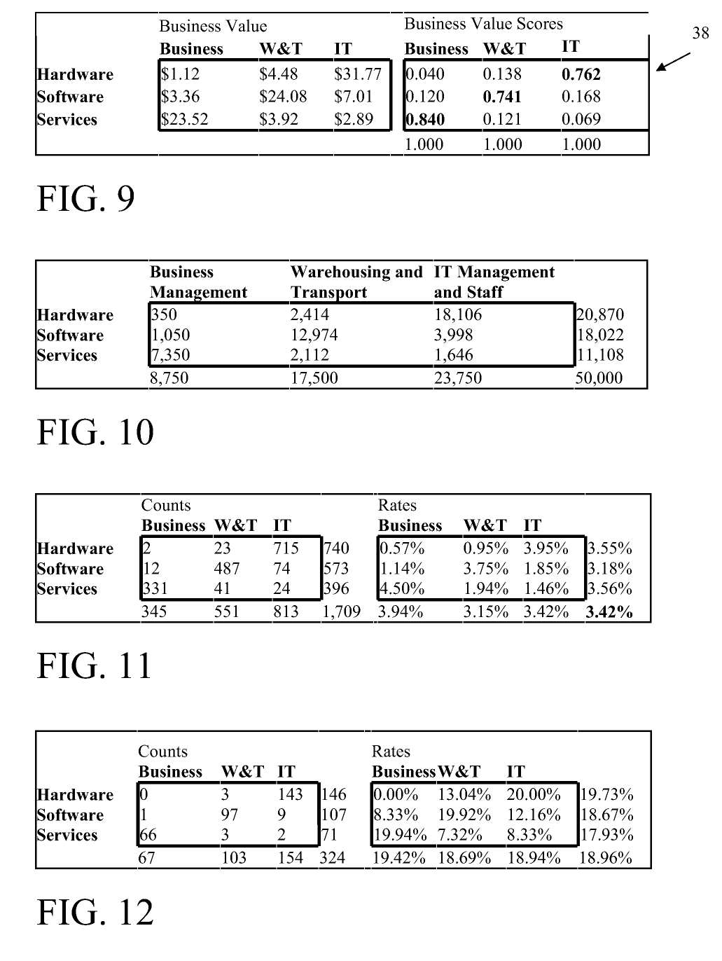

FIG. 5 depicts the actual breakdown of impressions (i.e., visitors) after the first week, and FIG. 6 shows the actual click throughs for each campaign/user profile. FIG. 7 depicts the actual number of post click conversions for each campaign/user profile and FIG. 8 depicts the projected revenue based on the assumption of a 4% post web conversion for average sales values stated above. As can be seen, the updated projected revenue using the initial business value scores has jumped to $636,600. Based on the revenue breakdown among the campaigns/user profiles, a rescoring operation takes place for implementation for the following week. FIG. 9 depicts revised business value scores 38 to be used for the second week.

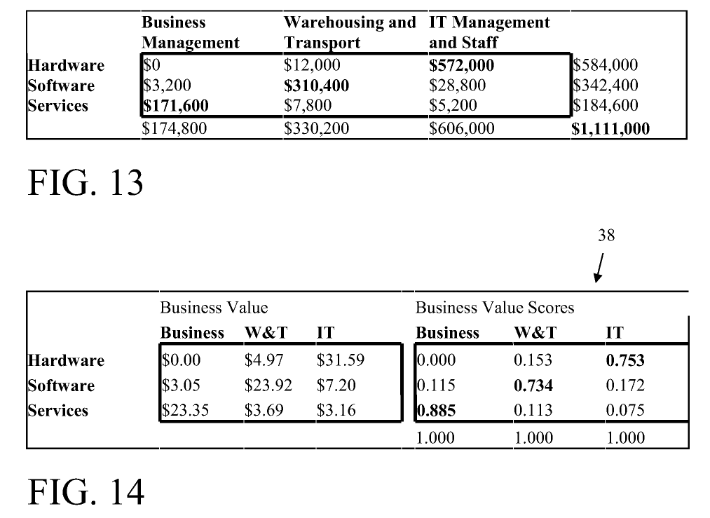

FIG. 10 depicts the impressions after the second week, with FIG. 11 showing the number of click throughs, and FIG. 12 showing the number of post click conversions. FIG. 13 shows the projected revenue, again based on a 4% post web conversion rate and average sales of $100,000, $80,000 and $65,000 for hardware, software and services, respectfully. As can be seen, the projected revenue for week 2 has jumped to $1,111,000. Finally, based on the breakdown of the projected sales, FIG. 14 shows the revised business value (per impression) and business value scores 38 for each campaign/profile to be used in week 3. The rescoring process would thus repeat each week.

As can be seen, the business value scores 38 adapt over time to identify the highest business values for each campaign/profile. The process updates the business value scores 38 based on visitor behavior, so little initial data is required, and the iterations continue automatically. The result is an increase in value for each visitor, an increase in the click through rates, and an increase in revenue.

Note that because the business value scores 38 may rely on some off-line activity, such as sales conversion rates, assumptions need be made, which can then later be captured and updated with actual data. For instance, in the example shown in FIGS. 2-14, a 4% off-line sales conversion rate is assumed. However, as actual data is obtained regarding the real off-line sales conversion rate, the information could be inputted into the business value generator 30, e.g., via an update facility provided by the administrative interface/reporting system 40. This would thus allow the off-line conversion rates to be regularly refreshed with current data to further improve the accuracy of the business value scores 38. In addition, the update facility would allow for manual setting of business value scores by an administrator.

In general, adaptive content management system 11 may be implemented on any type of computer system, which may be implemented as part of a client and/or a server. Such a computer system generally includes a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computer system and likewise may comprise any known type of transmission link, including electrical, optical, wireless, etc. Additional components, such as cache memory, communication systems, system software, etc., may be incorporated into the computer system.

Access to web portal 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising an adaptive content management system 11 could be created, maintained and/or deployed by a service provider that offers the functions described herein for customers. That is, a service provider could offer to provide adaptive content management in which content items could be assigned a business value score based on conversion rates and as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A web portal having an adaptive content management system for selectively displaying content to users, comprising:
a content selection system for selecting a content item from a set of content items to display to a user based on a profile of the user and a set of business value scores associated with the set of content items;
a data collection system for collecting performance metrics for users presented with the content items;
an initialization system for generating an initial set of business value scores; and
a business value generator for adaptively modifying the set of business value scores over time based on the performance metrics.

2. The web portal of claim 1, wherein the set of content items and associated set of business value scores are stored in a content database.

3. The web portal of claim 1, further comprising a user interface for displaying the selected content item and determining a profile of the user.

4. The web portal of claim 1, wherein the business value scores dictate a relative frequency each content item from the set of content items are to be shown to users having a predetermined user profile.

5. The web portal of claim 1, wherein the performance metrics include conversion data.

6. The web portal of claim 5, wherein the business value generator includes a business calculation system that calculates projected revenue based on the conversion data.

7. The web portal of claim 6, wherein the business value generator includes a scoring system that calculates business value scores based on the projected revenue.

8. The web portal of claim 1, wherein the business value generator includes a system for capturing conversion data occurring off-line.

9. The web portal of claim 1, wherein the business value scores are based on a metric selected from the group consisting of: revenue, cost savings, profit, total lifetime value, time, volume, and customer type.

10. The web portal of claim 1, further comprising an update system for manually resetting the business value scores.

11. A computer program product stored on a computer usable medium for selecting content for display to users visiting a network site, comprising:
program code configured for selecting a content item from a set of content items based on a profile of a user and a set of business values scores associated with the set of content items;
program code configured for collecting performance metrics for users presented with the content items;
program code configured for implementing an initial set of business value scores; and
program code configured for adaptively modifying the set of business value scores over time based on the performance metrics.

12. The computer program product of claim 11, wherein the set of content items and associated business value scores are stored in a content database.

13. The computer program product of claim 11, further comprising program code configured for displaying a selected content item and determining a profile of the user.

14. The computer program product of claim 11, wherein the business value scores dictate a relative frequency each content item from the set of content items are to be shown to users having a predetermined user profile.

15. The computer program product of claim 11, wherein the performance metrics include conversion data.

16. The computer program product of claim 15, further comprising program code configured for calculating projected revenue based on the conversion data.

17. The computer program product of claim 16, further comprising program code configured for calculating business value scores based on the projected revenue.

18. The computer program product of claim 11, further comprising program code configured for capturing conversion data occurring off-line.

19. The computer program product of claim 11, wherein the business value scores are based on a metric selected from the group consisting of: revenue, cost savings, profit, total lifetime value, time, volume, and customer type.

20. The computer program product of claim 11, further comprising program code configured for manually resetting the business value scores.

21. A method for selecting content to display to users visiting a network site, comprising:
implementing an initial set of business value scores for a set of content items;
selecting content items for display to users from the set of content items based on the initial set of business value scores;
collecting performance metrics for users presented with the content items; and
rescoring the set of business value scores over time based on the performance metrics.

22. The method of claim 21, comprising the further steps of:
identifying a profile of a user visiting the network site;
selecting a content item from a set of content items based on the profile of a user and the set of business values scores associated with the set of content items.

23. The method of claim 21, wherein the set of content items and associated business value scores are stored in a content database.

24. The method of claim 21, wherein the business value scores dictate a relative frequency each content item from the set of content items are to be shown to users having a predetermined user profile.

25. The method of claim 21, wherein the performance metrics include conversion data.

26. The method of claim 25, further comprising the step of calculating projected revenue based on the conversion data.

27. The method of claim 26, wherein the step of rescoring the business value scores is based on the projected revenue.

28. The method of claim 21, further comprising the step of capturing conversion data occurring off-line.

29. The method of claim 21, wherein the business value scores are based on a metric selected from the group consisting of: revenue, cost savings, profit, total lifetime value, time, volume, and customer type.

30. The method of claim 21, further comprising the step of manually resetting the business value scores.

31. A method for deploying an adaptive content management system, comprising:
providing a computer infrastructure being operable to:
implement an initial set of business value scores for a set of content items;
select content items for display to users from the set of content items based on the initial set of business value scores;
collect performance metrics for users presented with the content items; and
rescore the set of business value scores over time based on the performance metrics.
